(19) United States
(12) Patent Application Publication
(10) Pub. No.: US 2024/0126392 A1
(43) Pub. Date: Apr. 18, 2024

(54) TOUCH DISPLAY PANEL

(71) Applicants: WUHAN CHINA STAR OPTOELECTRNICS TECHNOLOGY CO., LTD., Wuhan, Hubei (CN); WUHAN CHINA STAR OPTOELECTRONICS SEMICONDUCTOR DISPLAY TECHNOLOGY CO., LTD., Wuhan, Hubei (CN)

(72) Inventor: Liang FANG, Wuhan, Hubei (CN)

(21) Appl. No.: 17/310,823

(22) PCT Filed: Jun. 17, 2021
(86) PCT No.: PCT/CN2021/100480

§ 371 Date: Aug. 25, 2021

(30) Foreign Application Priority Data
Jun. 8, 2021 (CN) 202110635366.6

(51) Int. Cl. G06F 3/041; G06F 3/047

(52) U.S. Cl. CPC G06F 3/04166; G06F 3/047

(57) ABSTRACT

The present application discloses a touch display panel including touch driving electrodes and touch sensitive electrodes. The touch display panel includes at least one specific region, some of touch electrode units in one specific region include touch driving electrode having a driving electrode body and first tooth-shaped portions protruding from the driving electrode body and touch sensitive electrode set having at least one sensitive electrode body and second tooth-shaped portions protruding from one sensitive electrode body.

### FIELD OF INVENTION

The present application relates to a field of display panels, especially to a touch display panel.

### BACKGROUND OF INVENTION

Display devices mainly comprise liquid crystal displays (LCDs), plasma display panels (PDPs), organic light emitting diodes (OLEDs), active-matrix organic light emitting diodes (AMOLEDs), which have a broad application space in products of vehicles, mobile phones, tablets, computers, and TVs.

Capacitive type touch panels are widely used. A basic principle of the capacitive type touch panel is to use tools such as finger or touch pen to generate a capacitor with the touch panel, and use the electrical signal formed by the change of the capacitor before and after the touch to confirm whether the display panel is touched and confirm the touch coordinate.

One important touch technology of capacitive type touch display panels is mutual capacitance, which can achieve a touch function by single or two layers of metal. With reference to FIG. 1, FIG. 1 is a schematic structural view of a conventional single layer mutual capacitance touch display panel 1. The single layer mutual capacitance touch display panel 1 comprises touch driving electrodes 2 and touch sensitive electrodes 3. In four corner regions of the display panel, the touch driving electrodes or the touch sensitive electrodes are influenced by display, a normal region is comparatively small such that coupling capacitance between corresponding driving electrode and sensitive electrode is small and cannot fulfill a touch performance specification, which finally results in reduced touch performance in this region.

Therefore, it is necessary to develop a touch display panel to overcome defects of the conventional technology.

### SUMMARY OF INVENTION

### Technical Issue

An objective of the present invention is to provide a touch display panel that can solve the issue that the coupling capacitance between the driving electrode and the sensitive electrode in the four corner regions in the conventional touch display panel is small.

### Technical Solution

To achieve the above objective, the present invention provides a touch display panel comprising: touch electrode units of a number of 1 to n arranged along a first direction, wherein n is an integer greater than 1; each of the touch electrode units comprising at least two touch driving electrodes arranged on a first straight line along a second direction; at least two touch sensitive electrodes arranged on a second straight line along the second direction, wherein the second direction is perpendicular to the first direction, the second straight line is parallel to the first straight line, and any one of the touch driving electrodes is disposed opposite to at least one of the touch sensitive electrodes; the touch display panel comprising at least one specific region, and some of the touch electrode units in one of the at least one specific region comprising: the touch driving electrode comprising a driving electrode body and first tooth-shaped portions protruding from the driving electrode body, wherein a first gap is defined between adjacent two of the first tooth-shaped portions; and a touch sensitive electrode set comprising at least one sensitive electrode body and second tooth-shaped portions protruding from one sensitive electrode body, wherein a second gap is defined adjacent between two of the second tooth-shaped portions, each of the first tooth-shaped portions is inserted into one second gap, and each of the second tooth-shaped portions is inserted into one first gap.

The first direction is a horizontal direction, i.e., a direction from left to right or from right to left; and the second direction is a vertical direction, i.e., a direction from top to bottom or from bottom to top.

Furthermore, in other embodiment, a number of the second tooth-shaped portions protruding from one sensitive electrode body is greater than 1.

Furthermore, in other embodiment, shapes of the first tooth-shaped portions and the second tooth-shaped portions are rectangular, or the shapes of the first tooth-shaped portions and the second tooth-shaped portions are trapezoidal.

Furthermore, in other embodiment, the touch driving electrodes and the touch sensitive electrodes are disposed in the same layer.

Furthermore, in other embodiment, in the first direction, the touch driving electrodes and the touch sensitive electrodes are disposed at intervals; for a first one of the touch electrode units and a second one of the touch electrode units: the touch sensitive electrodes in the first one of the touch electrode units are disposed adjacent to the touch driving electrodes in second one of the touch electrode units, and the touch sensitive electrodes in the first one of the touch electrode units are located between the touch driving electrodes in the first one of the touch electrode units the touch driving electrodes in the second one of the touch electrode units.

Furthermore, in other embodiment, the touch display panel further comprises touch lead wires of a number of 2n arranged along the first direction and a plurality of soldering pads arranged along the first direction; each touch lead wire comprises a touch driving lead wire and a touch sensitive lead wire, the touch driving lead wire is configured to connect the touch driving electrodes to the soldering pads, and the touch sensitive lead wire is configured to connect the touch sensitive electrodes to the soldering pads.

Furthermore, in other embodiment, wherein material of the touch driving lead wire and the touch sensitive lead wire can be low resistance conductive material such as indium tin oxide (ITO), silver paste, or MOALMO to lower an interval of wires, increase wiring precision such that a space of lead wires layout is reduced.

Furthermore, in other embodiment, the display panel comprises a display region and a non-display region, the specific region is located in the display region, and the soldering pads is located in the non-display region.

Furthermore, in other embodiment, the specific region is four corner regions of the display region and/or a under-the-screen camera region of the display region; and in the display region except for the four corner regions, shapes of the touch driving electrodes and the touch sensitive electrodes are rectangular.

Furthermore, in other embodiment, the touch driving lead wire connected to the soldering pads are not intersected with the touch sensitive lead wire.

Furthermore, in other embodiment, the touch display panel further comprises a circuit board and a chip, the soldering pads are electrically connected to the chip through the circuit board and is configured to transmit a signal between the touch electrode units and the chip.

Advantages

Compared to the conventional technology, advantages of the present invention are that: the present invention provides a touch display panel, by disposing first tooth-shaped portions protruding a driving electrode body and second tooth-shaped portions protruding from each sensitive electrode body in four corner regions of the display panel, a coupling area of touch driving electrodes and touch sensitive electrodes to achieve a touch performance specification to mitigate the issue of poor touch performance of four corner regions of the display panel to improve market competitivity of products.

### DESCRIPTION OF DRAWINGS

Specific embodiments of the present invention are described in details with accompanying drawings as follows to make technical solutions and advantages of the present invention clear.

FIG. 1 is a schematic structural view of a single layer mutual capacitance touch display panel provided by a first embodiment of the present invention;

FIG. 2 is a schematic structural view of a touch display panel provided by the first embodiment of the present invention;

FIG. 3 is a partially enlarged view of a specific region of the touch display panel of the first embodiment of the present invention; and

FIG. 4 is a partially enlarged view of a specific region of a touch display panel provided by a second embodiment of the present invention.

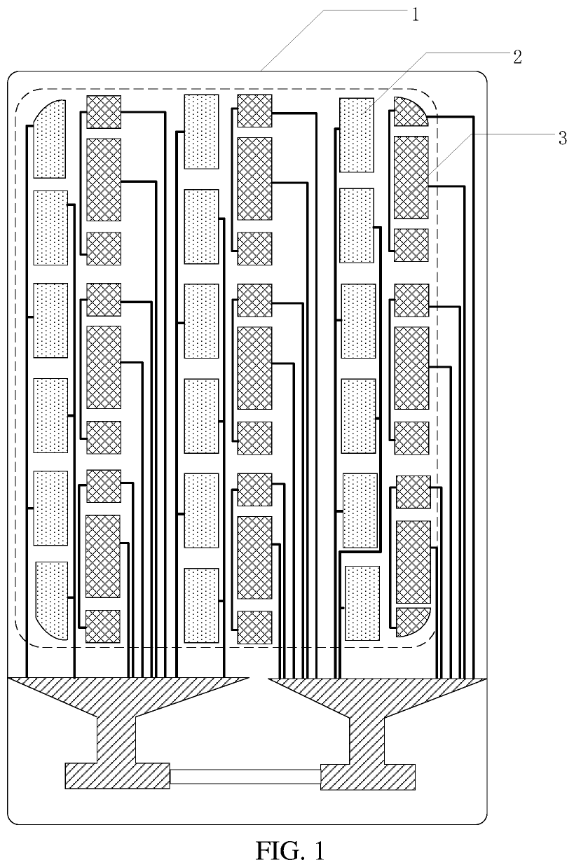

### INDICATION OF THE DRAWINGS IN THE RELATED ART

single layer mutual capacitance touch display panel—1;
touch driving electrodes—2; touch sensitive electrodes—3.

Indication of the drawings in the embodiment:
touch display panel—100; display region—101;
non-display region—102; touch electrode units—10;
touch lead wires—20; soldering pads—30;
chip—40; touch driving electrodes—110;
touch sensitive electrodes—120; specific region—103;
driving electrode body—111; first tooth-shaped portions—112;
first gap—113; sensitive electrode body—121;
second tooth-shaped portions—122; second gap—123;
touch driving lead wire—210; touch sensitive lead wire—220.

### DETAILED DESCRIPTION OF PREFERRED EMBODIMENTS

The technical solution in the embodiment of the present application will be clearly and completely described below with reference to the accompanying drawings in the embodiments of the present application. Apparently, the described embodiments are merely some embodiments of the present application instead of all embodiments. According to the embodiments in the present application, all other embodiments obtained by those skilled in the art without making any creative effort shall fall within the protection scope of the present application.

### First Embodiment

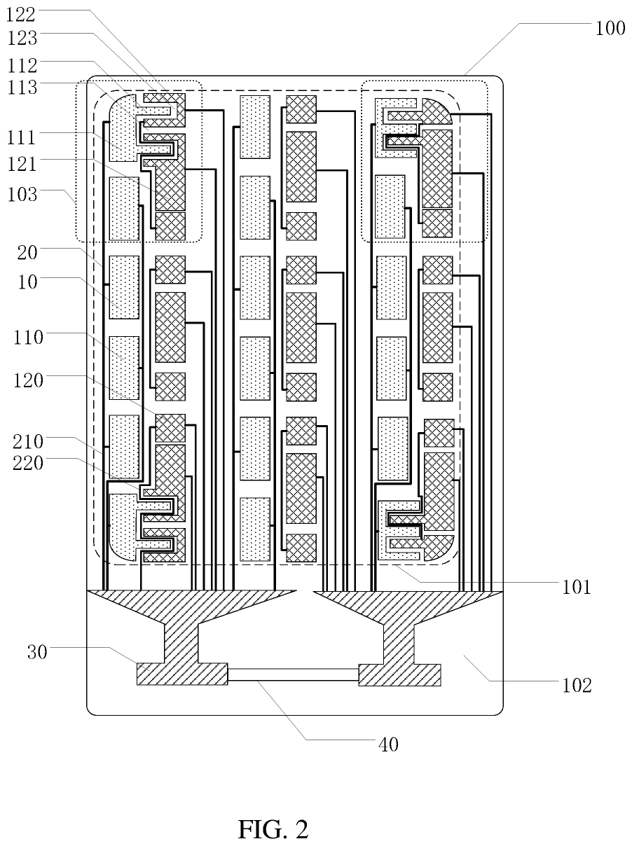

An embodiment of the present application provides a touch display panel 100. With reference to FIG. 2, the touch display panel 100 comprises a display region 101 and a non-display region 102, and first to n^{th} touch electrode units 10 of arranged along a first direction, touch lead wires 20 of a number 2n arranged along the first direction, and a plurality of soldering pads 30 arranged along the first direction. The touch electrode units 10 are located in the display region 101, and the soldering pads 30 are located in the non-display region 102.

n is an integer greater than 1. In the present embodiment, n is 3; and the first direction is a horizontal direction, i.e., a direction from left to right or a direction from right to left.

Each of the touch electrode units 10 comprises at least two touch driving electrodes 110 and at least two touch sensitive electrodes 120, touch driving electrodes 110 are arranged in a first straight line along a second direction. The touch sensitive electrodes 120 are arranged in a second straight line along the second direction, and the second direction is perpendicular to the first direction, the second straight line is parallel to first straight line.

Any one of the touch driving electrodes 110 is disposed opposite to at least one of the touch sensitive electrodes 120, the touch driving electrodes 110 and touch sensitive electrodes 120 are configured to be coupled together to form a plurality of mutual capacitance sensitive nodes, and a user's touch location information is determined by sensing variation of capacitance in the mutual capacitance sensitive nodes.

The second direction is a vertical direction, i.e., a direction from top to bottom or a direction from bottom to top.

In the first direction, the touch driving electrodes 110 and the touch sensitive electrodes 120 are disposed at intervals. For the first one of the touch electrode units 10 and the second one of the touch electrode units 10: the touch sensitive electrodes 120 in the first one of the touch electrode units 10 and the touch driving electrodes 110 in the second one of the touch electrode units 10 are disposed adjacent to one another, the touch sensitive electrodes 120 in the first one of the touch electrode units 10 are located between the touch driving electrodes 110 in the first one of the touch electrode units 10 and the touch driving electrodes 110 in the second one of the touch electrode units 10.

The touch driving electrodes 110 and the touch sensitive electrodes 120 are disposed in the same layer. The touch display panel 100 is a single layer mutual capacitance touch display panel 100. Optionally, manufacturing material of the touch driving electrodes 110 and the touch sensitive electrodes 120 is inorganic non-metal material or metal material. The inorganic non-metal material can be transparent material such as indium tin oxide. The metal material comprises one or more of titanium, aluminum, molybdenum, or nano silver.

In an embodiment, the touch driving electrodes 110 and the touch sensitive electrodes 120 are mesh touch electrodes. One of the mesh touch electrodes overlaps with a plurality of sub-pixels along a direction perpendicular to the display panel. the mesh touch electrode comprises a plurality of apertures, the apertures is exposed in light exiting region of the sub-pixels and can reduce light shielding of the touch driving electrodes 110 and the touch sensitive electrodes 120, and reduce light loss due to light extending through a touch electrode layer (a film layer in which the touch driving electrodes 110, the touch sensitive electrodes 120, and the touch lead wires 20 are located) during display, and guarantee brightness of the display panel. Especially for the driving electrode and the sensitive electrode made of metal material, a design of the mesh touch electrode can effectively decrease light loss due to light extending through the metal layer, which simultaneously guarantees touch performance and the brightness of the display panel.

The touch lead wires 20 comprises a touch driving lead wire 210 and the touch sensitive lead wire 220. The touch driving lead wire 210 is configured to connect the touch driving electrodes 110 to the soldering pads 30. The touch sensitive lead wire 220 is configured to connect to the touch sensitive electrodes 120 to the soldering pads 30. A head end of the touch driving lead wire 210 is connected to corresponding ones of the touch driving electrodes 110, and a proximal end of the touch driving lead wire 210 extends into the non-display region 102 to connect corresponding ones of the soldering pads 30. The head end of the touch sensitive lead wire 220 is connected to corresponding ones of the touch sensitive electrodes 120, and a proximal end of the touch sensitive lead wire 220 extends into the non-display region 102 to connect corresponding ones of the soldering pads 30.

Material of the touch driving lead wire 210 and the touch sensitive lead wire 220 can be low resistance conductive material such as indium tin oxide (ITO), silver paste, or MOALMO to lower an interval of wires, increase wiring precision such that a space of lead wires layout is reduced.

The touch driving lead wire 210 and the touch sensitive lead wire 220 connected to the soldering pads 30 are not intersected to prevent utilizing a bridge structure and lower manufacturing difficulty, which can be achieved by disposing soldering pads 30 along the first direction in a sequence.

The touch display panel 100 further comprises a circuit board (not shown in the figures) and a chip 40. The circuit board and the chip 40 are also located in the non-display region 102. The soldering pads 30 are electrically connected to chip 40 through the circuit board, and is configured to transmit signals between the touch electrode units 10 and the chip 40 to achieve touch sensing.

The touch display panel 100 comprises at least one specific region 103, and the specific region 103 is located in the display region. Some of the touch electrode units 10 in one specific region 103 comprise sets of the touch driving electrodes 110 and the touch sensitive electrodes 120. The touch driving electrode 110 comprises a driving electrode body 111 and a first tooth-shaped portion 112 protruding from the driving electrode body 111. A first gap 113 is defined between adjacent two of the first tooth-shaped portions 112. The touch sensitive electrode set comprises two sensitive electrode bodies 121 and second tooth-shaped portions 122 protruding from each sensitive electrode body 121. A second gap 123 is defined between any adjacent two of the second tooth-shaped portions 122.

Each of the first tooth-shaped portions 112 is inserted into one second gap 123, each second tooth-shaped portions 122 is inserted into one first gap 113. Disposing the first tooth-shaped portions 112 protruding from the driving electrode body 111 and second tooth-shaped portions 122 protruding from each sensitive electrode body 121 in the specific region 103 increases a coupling area of the touch driving electrodes 110 and the touch sensitive electrodes 120 and mitigate the issue of poor touch performance in the specific region 103.

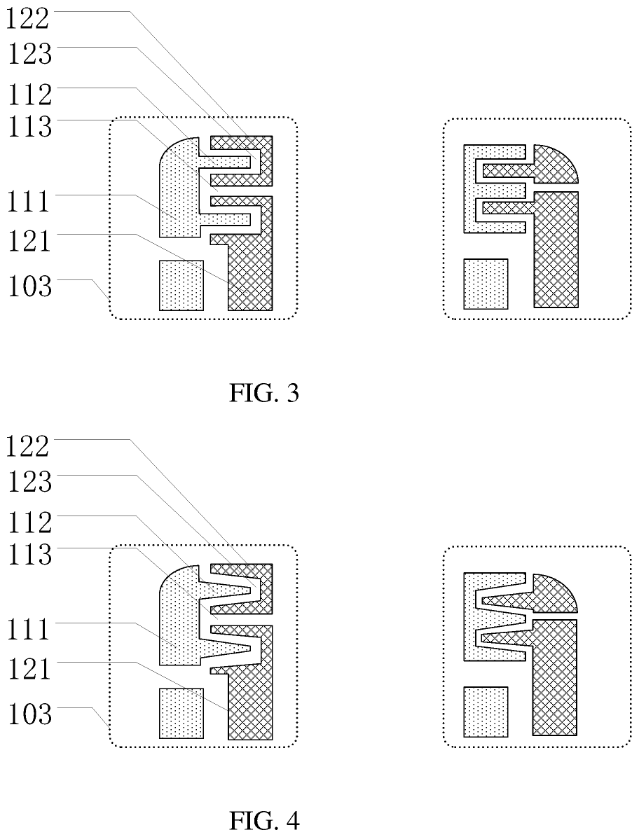

In the present embodiment, shapes of the first tooth-shaped portions 112 and the second tooth-shaped portions 122 are rectangular, as shown in FIG. 3.

A number of the first tooth-shaped portions 112 protruding from the driving electrode body 111 is two. In other embodiment, the number of the first tooth-shaped portions 112 protruding from the driving electrode body 111 can be one or other integer. In the present embodiment, a number of the second tooth-shaped portions 122 protruding from each sensitive electrode body 121 is one or more than one. The shapes of the touch driving electrodes 110 and the touch sensitive electrodes 120 in regions except for of the four corner regions of the display region are rectangular.

In the present embodiment, the specific region 103 can be four corner regions of the display region. In other embodiment, the specific region 103 can also be a under-the-screen camera region of the display region, the specific region 103 is not limited here as long as it is a region with smaller areas of the touch driving electrodes 110 and the touch sensitive electrodes 120.

### Second Embodiment

The structure of the touch display panel 100 in the present embodiment also has touch driving electrodes 110 and touch sensitive electrodes 120 that are substantially the same as those in the first embodiment. The same structures can refer to corresponding descriptions in the first embodiment and is not described repeatedly here. A main difference between the second embodiment from the first embodiment is that in the present embodiment, in the specific region 103, shapes of the first tooth-shaped portions 112 and the second tooth-shaped portions 122 are trapezoidal, as shown in FIG. 4.

In other embodiment, the shapes of the first tooth-shaped portions 112 and the second tooth-shaped portions 122 can also be other shapes, and it is not limited here as long as the coupling capacitance between the touch driving electrodes 110 and the touch sensitive electrodes 120 can be increased.

The present invention provides a touch display panel, by disposing first tooth-shaped portions protruding a driving electrode body and second tooth-shaped portions protruding from each sensitive electrode body in four corner regions of the display panel, a coupling area of touch driving electrodes and touch sensitive electrodes to achieve a touch performance specification to mitigate the issue of poor touch performance of four corner regions of the display panel to improve market competitivity of products.

In the above-mentioned embodiments, the descriptions of the various embodiments are focused. For the details of the embodiments not described, reference may be made to the related descriptions of the other embodiments.

The touch display panel provided by the embodiment of the present application are described in detail as above. The principles and implementations of the present application are described in the following by using specific examples. The description of the above embodiments is only for assisting understanding of the technical solutions of the present application and the core ideas thereof. Those of ordinary skill in the art should understand that they can still modify the technical solutions described in the foregoing embodiments are or equivalently replace some of the technical features. These modifications or replacements do not depart from the essence of the technical solutions of the embodiments of the present application.

What is claimed is:

1. A touch display panel, comprising:
touch electrode units of a number of 1 to n arranged along a first direction, wherein n is an integer greater than 1;
each of the touch electrode units comprising
at least two touch driving electrodes arranged on a first straight line along a second direction;
at least two touch sensitive electrodes arranged on a second straight line along the second direction, wherein the second direction is perpendicular to the first direction, the second straight line is parallel to the first straight line, and any one of the touch driving electrodes is disposed opposite to at least one of the touch sensitive electrodes;
the touch display panel comprising at least one specific region, and some of the touch electrode units in one of the at least one specific region comprising:
the touch driving electrode comprising a driving electrode body and first tooth-shaped portions protruding from the driving electrode body, wherein a first gap is defined between adjacent two of the first tooth-shaped portions; and
a touch sensitive electrode set comprising at least one sensitive electrode body and second tooth-shaped portions protruding from one sensitive electrode body, wherein a second gap is defined adjacent between two of the second tooth-shaped portions, each of the first tooth-shaped portions is inserted into one second gap, and each of the second tooth-shaped portions is inserted into one first gap.

2. The touch display panel according to claim 1, wherein a number of the second tooth-shaped portions protruding from one sensitive electrode body is greater than 1.

3. The touch display panel according to claim 1, wherein shapes of the first tooth-shaped portions and the second tooth-shaped portions are rectangular, or the shapes of the first tooth-shaped portions and the second tooth-shaped portions are trapezoidal.

4. The touch display panel according to claim 1, wherein the touch driving electrodes and the touch sensitive electrodes are disposed in the same layer.

5. The touch display panel according to claim 1, wherein in the first direction, the touch driving electrodes and the touch sensitive electrodes are disposed at intervals; for a first one of the touch electrode units and a second one of the touch electrode units, the touch sensitive electrodes in the first one of the touch electrode units are disposed adjacent to the touch driving electrodes in second one of the touch electrode units, and the touch sensitive electrodes in the first one of the touch electrode units are located between the touch driving electrodes in the first one of the touch electrode units the touch driving electrodes in the second one of the touch electrode units.

6. The touch display panel according to claim 1, wherein the touch display panel further comprises touch lead wires of a number of 2n arranged along the first direction and a plurality of soldering pads arranged along the first direction; each touch lead wire comprises a touch driving lead wire and a touch sensitive lead wire, the touch driving lead wire is configured to connect the touch driving electrodes to the soldering pads, and the touch sensitive lead wire is configured to connect the touch sensitive electrodes to the soldering pads.

7. The touch display panel according to claim 6, wherein the display panel comprises a display region and a non-display region, the specific region is located in the display region, and the soldering pads is located in the non-display region.

8. The touch display panel according to claim 7, wherein the specific region is four corner regions of the display region and/or a under-the-screen camera region of the display region; and in the display region except for the four corner regions, shapes of the touch driving electrodes and the touch sensitive electrodes are rectangular.

9. The touch display panel according to claim 6, wherein the touch driving lead wire connected to the soldering pads are not intersected with the touch sensitive lead wire.

10. The touch display panel according to claim 6, wherein the touch display panel further comprises a circuit board and a chip, the soldering pads are electrically connected to the chip through the circuit board and is configured to transmit a signal between the touch electrode units and the chip.
